(19) United States
(12) Patent Application Publication
(10) Pub. No.: US 2002/0197979 A1
(43) Pub. Date: Dec. 26, 2002

(54) Authentication system for mobile entities

(76) Inventor: Michaela Catalina Vanderveen, Tracy, CA (US)

Correspondence Address: STRAUB & POKOTYLO, 1 BETHANY ROAD, SUITE 83, BUILDING 6, HAZLET, NJ, 07730, US

(21) Appl. No.: 10/152,655

(22) Filed: May 21, 2002

Related U.S. Application Data
(60) Provisional application No. 60/292,328, filed on May 22, 2001.

(51) Int. Cl. H04M 1/68; H04M 1/66

(52) U.S. Cl. 455/410; 455/411

(57) ABSTRACT

Verification and authentication methods for use in mobile communications systems where base stations do not have direct access to a shared secret common to a security server and mobile node are described. Unilateral authentication of a mobile node by a base station is augmented through the use of a mutual authentication token (MAT) generated by the security server and the mobile node as a function of the shared secret. With each handoff the MAT generated by the security server is passed from base station to base station via a secure communications channel. After each handoff the mobile node and new base station perform a unilateral authentication operation and establish a new encryption key that is a function of the MAT. Existence of a trust relationship between a new base station and the last base station is verified by the new base station's ability to properly encrypt data.

### RELATED APPLICATIONS

This application claims the benefit of U.S. Provisional Application S. No. 60/292,328 filed May 22, 2001 which is hereby expressly incorporated by reference.

### FIELD OF THE INVENTION

The present invention is directed to methods and apparatus for performing verification and/or authentication and, more particularly to verification and authentication techniques suitable for use in communications systems with mobile entities.

### BACKGROUND

Theft of services and information is of growing concern in the communications business. Mobile communications devices are sometimes monitored by unauthorized individuals. Mobile communications devices are often programmed to mislead a base station as to the device's identity in order to allow the user of the device to steal communications services. “Cloned” cell phones, which use stolen, copied or modified device identification information when identifying themselves to base stations, cost the communications industry large sums of money every year.

In order to reduce the risk of stolen services and/or information, mobile communications systems should include greater security measures than are found in some older systems. As part of the new security measures, it is desirable that base stations and mobile devices be able to perform an authentication process to verify one another's identity and/or legitimacy. In addition, to prevent the theft of information through eavesdropping, communications systems should include a method whereby data transmissions may be encrypted in a reasonably secure manner following authentication.

Mobile communications systems frequently include a plurality of base stations, e.g., one per cell, and mobile nodes that may move, e.g., from cell to cell. As a mobile node moves from cell to cell, it normally ceases interacting with the base station in the cell it is leaving and begins interacting with the cell into which it is entering. The passing of the responsibility for interacting with a mobile device from one base station to another is frequently called a “hand off” and often involves passing of information concerning communication with the mobile node from the current base station to the new base station. The transmitted information is sometimes called state information and may include security information used to interact with the mobile node.

State information may be passed from one base station to another over a reasonably secure communications link, e.g., using (private) fiber optic lines and/or public networks by employing data authentication and encryption. Thus, the interception and use of state information passed from one base station to another is of much lower concern, in terms of theft and unauthorized access, than over-the-air transmissions between mobile nodes and base stations, which can be easily intercepted and monitored. Thus a relatively high degree of security exists in terms of state information passed between base stations. This allows a mobile node to have some degree of confidence in the authenticity and legitimacy of a new base station that uses security information obtained from another base station with whom the mobile node previously performed a mutual authentication operation. The ability to trust in the authenticity of a new base station based on the fact that it has security information passed to it from a previous base station with which a mobile node developed a trust relationship is sometimes called transitive trust.

In order to provide scalable security in mobile communications systems, it has been suggested that a secure server be used to store a piece of secret data pertaining to the mobiles (devices and/or users) in the system. The shared secret data is known only to a secure server and the individual mobile node, which uses the secret data for authentication/encryption purposes. For security purposes, in such a system, it is the security server and not the base stations that have direct access to the shared secret.

The following procedure is accepted in the state of the art as a robust method to achieve mutual authentication based on a shared secret piece of data:

1. The parties involved agree in advance on a secret piece of data, which they both know and no other unauthorized parties know.

2. Each party generates at the time of authentication a nonce, i.e. a new, unpredictable random number to be used only once, which they exchange with the other party. The nonce is sometimes called a challenge since a response to the transmitted nonce is expected.

3. Each party then uses both of the exchanged random numbers and the shared secret data to generate at least two authentication responses. Other quantities may be generated simultaneously.

4. The parties exchange these responses and thus verify the authenticity of the other party, as follows: party A generates two authentication responses, ResponseA and ResponseB. Independently, party B generates two authentication responses, ResponseA′ and ResponseB′. If indeed party A and party B used the same secret data to generate these responses, then party A's ResponseA should exactly match party B's ResponseA′ and similarly for ResponseB. To verify authenticity, party A sends its ResponseA to party B, and party B sends its ResponseB′ to party A. Party A verifies that the ResponseB it generated matches the ResponseB′ that party B sent it; if they do not match, party A considers party B to have failed authentication. A correspondingly similar procedure applies to party B which compares received ResponseA to its generated ResponseA′.

In an envisioned scenario, the base station and the mobile node may wish to perform mutual authentication before encryption of data being exchanged begins. For security purposes, in the above described system, the base stations in the network do not have direct access to the secret piece of data (also called “shared secret data”) that needs to be used by the base station to achieve mutual authentication according to the above described procedure. However, the security server that the base stations in the network are connected to via a secure link, is the keeper of the shared secret data. Accordingly, in such a system the security server is responsible for the generation of the quantities used by a base station to perform mutual authentication with a mobile node as part of the above described process. In the example of mutual authentication above, the security server would have to at least generate ResponseA and ResponseB and send them to the respective base station. The base station itself can perform the checking of the authentication response from the mobile node; alternatively, the base station can act as a pass-through device and the server performs the checking of the mobile node's response. Whether or not the base station acts as a pass-through device for this mutual authentication phase, the mobile node must receive the server's part of the authentication response and verify it. The mobile node considers the base station and server authenticated if the base station/server sends the right authentication response; in either case, it is indicated to the mobile that the base station is in secure, authenticated communication with the security server.

It has then become apparent that such a server-assisted mutual authentication procedure involves communication between the base station currently serving the mobile and the security server located somewhere in the network. This communication poses an overhead, especially in terms of time and processing power. It is thus burdensome to perform mutual authentication each time the mobile node changes its serving base station.

It would be desirable if a mobile node and base station could undergo a handoff operation from one base station to another, and interact to select a new encryption key that would be reasonably secure and reliable even if the encryption key used by the previous base station were compromised. From a security perspective, it is desirable that the new key not be easily derivable from information which was broadcast between the mobile node and base station even in cases where the previously used encryption key has been successfully compromised, e.g., through some form of hacking based on the information exchanged between a base station and the mobile node.

Accordingly, there is a need for improved authentication and verification techniques which are well suited for use in systems with mobile communications nodes.

### BRIEF DESCRIPTION OF THE FIGURES

FIG. 1 illustrates a mobile communications system which implements the verification and authentication method of the present invention.

FIG. 2 illustrates a security server suitable for use in the communications system of FIG. 1.

FIG. 3 illustrates a base station suitable for use in the system of FIG. 1.

FIG. 4 illustrates a mobile node that may be used in the system of FIG. 1.

FIG. 5 illustrates steps performed by a base station when a mobile node is initially activated and seeks to interact with a base station present in system shown in FIG. 1.

FIG. 6 illustrates steps performed by a base station following a handoff of a mobile node from another base station.

FIG. 7 illustrates steps performed by a mobile node in accordance with the present invention.

FIG. 8 illustrates the generation of a base station response, mobile node response, mutual authentication token and optionally encryption key, in accordance with the present invention from information exchanged as party of a mutual authentication process.

FIG. 9 illustrates generation of a key and mobile node response as part of a unilateral authentication process.

FIG. 10 illustrates the generation of a new encryption key as a function of a mutual authentication token and an existing key.

### SUMMARY OF THE INVENTION

The methods and apparatus of the present invention augment unilateral authentication of a mobile node by a base station in that the mobile node can verify the existence of a trust relationship between a new base station and the last base station. The new base station's ability to properly encrypt and decrypt data following generation of a new encryption key using information, referred to herein as a mutual authentication token (MAT), that should have been passed from the previous base station to the current base station via a secure communications channel serves as an indicator of the new base station's authenticity and relationship with the previous base station.

The steps included in one exemplary embodiment of the present invention can be described as follows:

1) Upon mutual authentication, a Mutual Authentication Token (MAT) is generated as a function of a shared secret common to the mobile node and a security sever to which the base station is linked by a secure communications channel. The MAT, along with other security information is supplied by the security server to the base station that is interacting with the mobile node. In one particular embodiment the MAT is part of the output of the function used to generate the base station response from the shared secret by the security server as part of the mutual authentication procedure. The MAT is valid until the next mutual authentication operation or until a timer associated with the MAT expires.

2) Upon handoff from the base station which was involved in the mutual authentication operation, the base station passes the current MAT to the next base station, along with other mobile node specific security parameters. With each subsequent handoff the MAT is also passed along to each new base station as part of the handoff process. After each handoff the mobile node and the new base station may proceed with unilateral authentication of the mobile node and optionally, encryption key establishment. Encryption key establishment involves generating a new encryption key as a function of the MAT transferred between the previous and new base station.

3) The final key that is actually used for encryption following a handoff is now a function of the MAT which is never transmitted between a base station and a mobile node. Thus, by using the MAT in accordance with the present invention, replay attacks which are based on the replay of information previously exchanged between the mobile node and base station can be thwarted. In one embodiment the new encryption key is generated by performing an exclusive-or operation between the MAT and an encryption key generated as part of the unilateral authentication of the mobile node with a new base station.

Through use of the MAT in accordance with the present invention, the mobile node is assured that if a base station can encrypt messages sent to the mobile node, the base station is in a trusting relationship with the previously deemed trusted base station and can also be trusted. This is because the MAT generated during the last mutual authentication is needed to produce the final encryption key and because the MAT is transmitted between base stations over a secure communications channel that is likely to be inaccessible to rogue base stations.

The technique of the present invention provides a greater degree of security than unilateral authentication of mobile nodes with relatively little overhead in terms of added delays. Delays associated with base stations having to contact a secure server where the mobile node's shared secret is stored are largely avoided through the use of the MAT since access to the shared secret is not required following each unilateral authentication and new key establishment, such as the case upon handoff.

Additional features of the present invention are discussed below in the detailed description which follows.

### DETAILED DESCRIPTION OF THE INVENTION

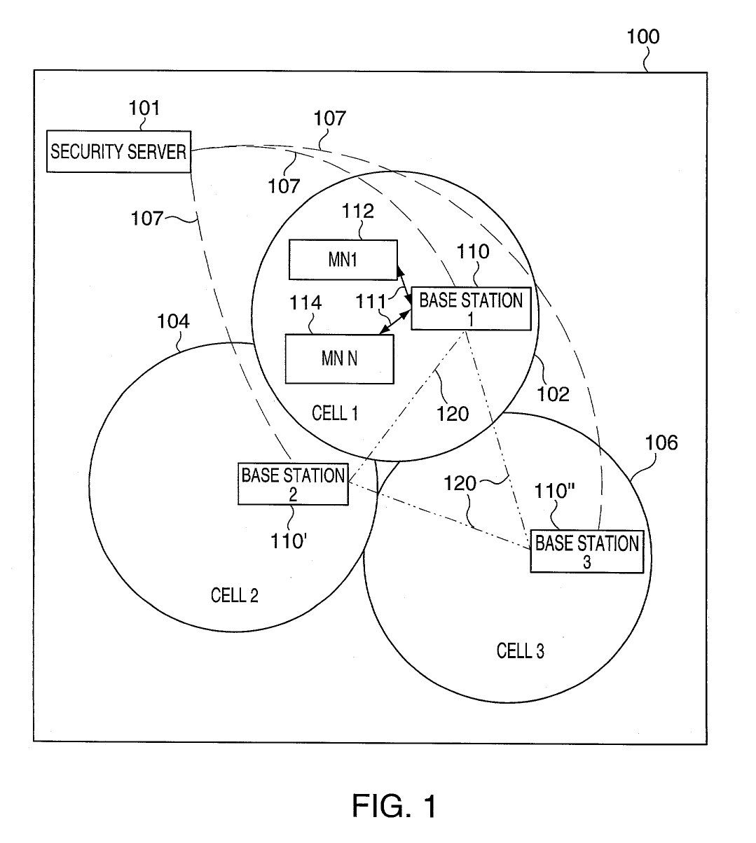

FIG. 1 illustrates a communication system 100 implemented in accordance with the present invention. The system 100 comprises a security server 101, and a plurality of communications cells cell 1 102, cell 2 104, and cell 3 106. Each of the cells, corresponds to a different but potentially overlapping geographic region, includes a base station 110, 110′ 110″, which can interact with one or more mobile communications devices, referred to as mobile nodes, which enter or are located in the cell. Each cell may also include one or more mobile nodes 112, 114 which communicate with the base station 110, e.g., via an over the air channel 111 or some other form of communications channel such as a land line. Mobile nodes may be, e.g., cell phones and other types of wireless devices, e.g., notebook computers and/or personal data assistants (PDAs) which include wireless modems. Base stations from the cells 102, 104, 106 can communicate with security server 101 via secure communications channels 107. Such channels may be, e.g., fiber optic lines, telephone lines or some other type of secure communications channel. Known data encryption and authentication techniques may be used on the communications channel 107 to ensure security. In addition to being coupled to the security server 101, each of the base stations 110, 110′ and 110″ in the communication systems 100 are coupled together by secure communications channels 120. Communications channels 120 which may be implemented in the same manner as communications channels 107 are used for transmitting information, e.g., state information relating to communications with mobile nodes, between base stations.

State information that is passed between base stations, e.g., stations 110, 110′, includes information used by the base station to interact with the mobile node. Such information is normally passed in a secure manner from a first base station with which a mobile node interacts to a second base station when the mobile node leaves the coverage area of the first base station and enters the coverage area of the second base station. For example, if mobile node 112 were to leave cell 1 102 and enter cell 2 104, base station 1 110 would transmit state information relating to mobile node 112 over the secure channel 120 to base station 2 110. As will be discussed below, the transmitted state information may include security information such as mobile node challenges (MNCs), mobile node expected responses (MNERs), encryption keys, and a mutual authentication token generated by the security server 101, e.g., as part of or following a mutual authentication operation.

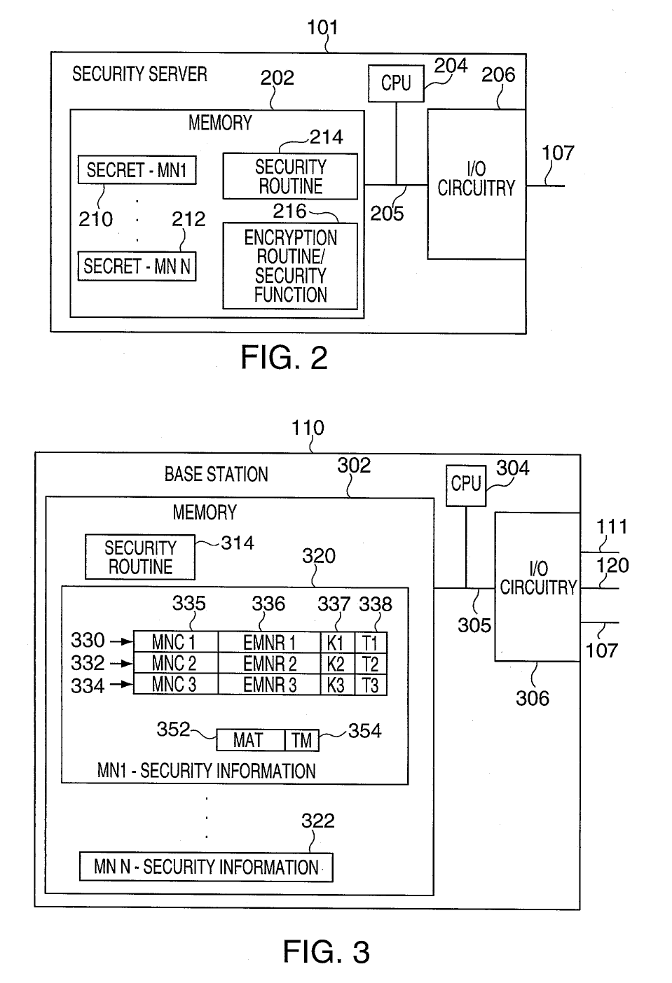

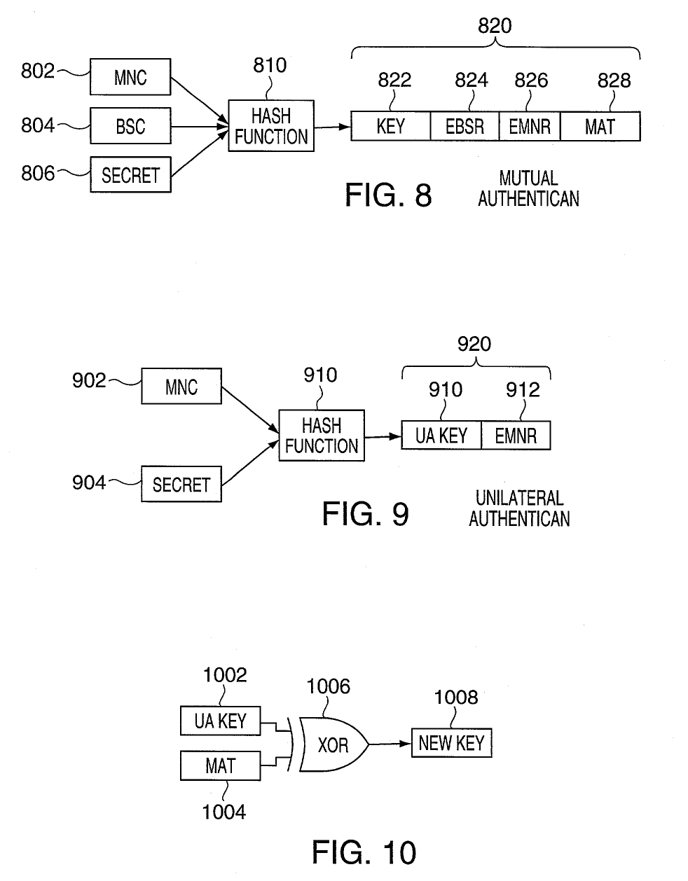

FIG. 2 shows the security server 101 of FIG. 1 in greater detail. The security server 101 includes memory 202, a central processing unit 204 and I/O circuitry 206 which are coupled together by bus 205. The I/O circuitry 206 includes transmitter and receiver circuitry for coupling the internal components of the security server 101 to communications channel 107. The memory 202 includes information, e.g., secrets 210 through 212, one for each mobile node which may interact with a base station coupled to the security server 101. Each secret is a set of bits representing, e.g., a number, which is stored in the corresponding mobile node. For example, secret 210 has the same value as the secret stored in mobile node 1 112. Secret 212 has the same value as the secret stored in mobile node N 114. In addition to the stored secrets, the memory 202 includes security routine 214 and encryption routine 216. Security routine 214 includes instructions that, when executed by CPU 204, cause the server 101 to perform security operations for base stations 110, 110′ and 110″ in accordance with the present invention. These functions include performing mutual authentication operations such as generating a mobile node challenge (MNC), a mobile node expected responses (MNER), and a base station response (BSR) that is generated in response to a received base station challenge (BSC). These operations are performed using the shared secret 210 or 212 corresponding to the mobile node with which a base station is interacting. In accordance with the present invention the security routine 214 is also responsible for generating, using the stored shared secret corresponding to a mobile node, a mutual authentication token (MAT) and a set of keys, MNCs and MNRs to be used by base stations over a period of time when interacting with a mobile node following a successful mutual authentication operation. Security routine 214 can call encryption routine 216 to generate the above mentioned values used in mobile node verification/authentication operations. Encryption routine 216 may be implemented as a security function that operates as will be discussed further below with regard to FIGS. 8 and 9.

FIG. 3 illustrates the exemplary base station 110 shown in FIG. 1 in greater detail. The base station 110 includes a CPU 304, I/O circuitry 306 and memory 302 which are coupled together by bus 305. I/O circuitry 306 includes receiver/transmitter circuitry which allows the base station 110 to interact with mobile nodes over the air communications channel 111, with other base stations via secure communication channel 120 and with the security server 101 via secure communications channel 107.

The base station's memory includes a security routine 314 which includes computer instructions which, when executed by CPU 304, cause the base station 110 to perform verification, authentication and other communications operations in accordance with the present invention. It also is responsible for encryption/decryption of data transmitted to/from a mobile node using an encryption key generated using the method of the invention. Memory 302 also includes a set of security information 320, 322 corresponding to each individual mobile node 112, 114 with which the base station 110 interacts. The set of security information 320, 322 is part of the state information which is passed from base station to base station as part of a mobile node handoff operation. In some embodiments used sets of CRK are not passed to another base station upon handoff. Thus, in such embodiments, upon handoff a new base station receives the remaining unused sets of CRK information. Thus, with time, base stations serving the mobile will run out of CRK sets requiring it to obtain more sets by contacting the security server.

Security information 320, which corresponds to MN1 112 is exemplary of the security information stored by a base station 110 for each individual mobile node 112, 114 with which it interacts. Security information 320 includes a plurality of mobile node challenge/response/key (CRK) sets 330, 332, 334 generated by the server 101. Each set 330, 332, 334 includes a mobile node challenge MNC 335, an expected mobile node response 336, key 337 and a timer T 338 indicating the period for which each CRK set is valid.

As will be discussed below, CRK sets 330, 332, 334 are generated by the security server 101 using the secret 210 corresponding to the mobile node for which the CRK set are sent. CRK sets are suitable for use in unilateral authentication operations, e.g., after mutual authentication operation has been performed. In addition to CRK sets 330, 332, 334 the set of security information 320 includes a mutual authentication token (MAT) 352 and a corresponding timer TM 354. As will be discussed below, the MAT 352 is generated by the security server 101. The MAT 352 is generated using the shared secret 210 corresponding to a mobile node following, or as part of, a mutual authentication operation. The MAT 352 is passed in a secure manner from base station 110 to base station 110′ as part of the state information communicated during a handoff operation. Timer TM 354, which indicates the lifespan of the corresponding MAT 352, normally has a longer duration then the CRK set timers 338. As will be discussed below, the MAT 354 is used, in various embodiments, following a unilateral mobile node authentication processes to generate a new encryption key that is used to encrypt communications between an mobile node and base station. In this manner, a mobile node can be reasonably assured of the authenticity of the base station with which it interacts since a rogue base station is unlikely to have access to the MAT 352 generated by the security server 101 using the shared secret.

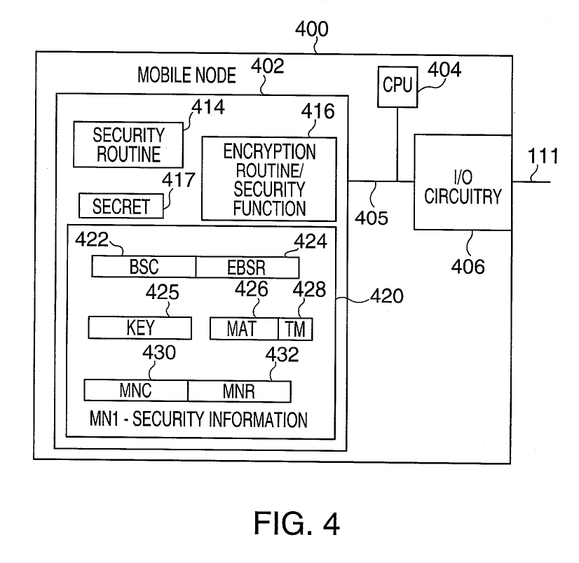

FIG. 4 illustrates a mobile node 400 which may be used as any one of the mobile nodes 112, 114 shown in FIG. 1. The mobile node 400 includes memory 402, a central processing unit 404 and I/O circuitry 406 which are coupled together by bus 405. The I/O circuitry 406 includes transmitter and receiver circuitry for coupling the internal components of the mobile node to communications channel 111. The memory 402 includes information, e.g., secret 417 and security information 420. The secret 417 matches the corresponding secret 210 stored in the security server 101 assuming the mobile node 400 correspond to the mobile node 112 of FIG. 1.

The memory 402 also includes security routine 414 and encryption routine 416. Security routine 414 includes instructions that, when executed by CPU 404, is responsible for performing verification/authentication as well as data encryption functions. Since the mobile node 400 stores the secret 417 it is capable of generating, using security function 416, much of the security information 420 stored in memory 402.

In particular the security routine 414 can generate base station challenges such as BSC 422, expected base station responses such as EBSR 424, encryption key 425, MAT 426, TM 428. The mobile node 400, under direction of security routine 414, is also capable of generating mobile node responses such as MNR 432 in response to a received mobile node challenge MNC 430.

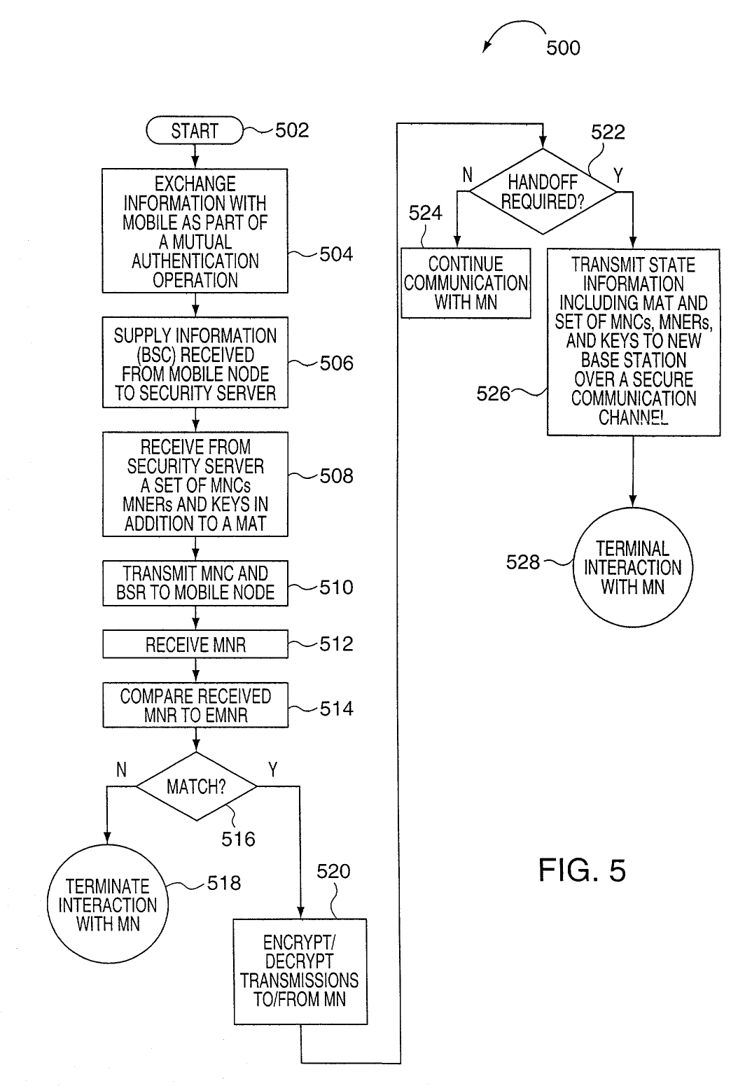

FIG. 5 illustrates the steps of the method of the present invention that are performed by a base station 110 when a mobile node 112 attempts to begin interacting with a base station 110 in the system 100 for the first time or other subsequent times as prescribed by the communications system policy.

In start step 502, the base station 110 is active and monitoring for signals from a mobile node. In step 504, the base station 110 exchanges information with the mobile node 112 as part of a mutual authentication and verification operation. As part of this exchange, the base station 110 receives a nonce to be used as the base station challenge (BSC) from the mobile node 112. In step 506, the base station 110 supplies the received BSC to the security server 101 over secure communications channel 107.

In response to receiving the BSC, the security server's security routine 214 generates, e.g., using a random number generation subroutine, a nonce for use as a mobile node challenge (MNC). In addition, the security routine 214 generates a base station response (BSR) to the received BSC, an expected mobile node response (EMNR), an encryption key, and a mutual authentication token (MAT). In one particular embodiment, as part of the mutual authentication and verification operation this information is generated using security function 216 in the manner shown in FIG. 8.

As shown in FIG. 8, the exemplary security function 810 receives an MNC 802, a BSC 804 and a secret 806. For input purposes some of these values maybe concatenated together. By performing a hashing or similar operation using the input values 802, 804, 806, the security function 810 produces a set of bits 820 representing security information. Examples of security functions known in the art are message authentication codes (MAC), hash functions, and keyed hash functions or “HMAC”. The generated security information includes an expected base station response (EB SR) 824, a mobile node response 826, a mutual authentication token 828, and optionally an encryption key 822. In the case of a mutual authentication operation performed by the server 101, the MNC 802 is the MNC generated by the server 101, the BSC 804 is the BSC generated by the mobile node. In addition, the secret 806 is the shared secret 210 common to the security server 101 and the mobile node 112 being authenticated.

Accordingly, in the exemplary embodiment shown in FIG. 8 a MAT 828 and the optional initial encryption key 822 are generated as a function of a shared secret and the challenges 802, 804, 806 exchanged between the mobile node 112 and base station 110 as part of the initial mutual authentication process. A timer may be associated with the MAT 828 which indicates the period of time the MAT 828 is to remain valid.

In addition to generating the information 820 relating to the initial mutual authentication process, the security server 101 may also generate several sets of information to be used for unilateral authentication purposes of the mobile node 110, e.g., after handoff or expiration of one or more timers.

FIG. 9 illustrates how the server 101 may generate, from the shared secret 904 and a mobile node challenge 902, a set of information 920 to be used for unilateral authentication purposes. In this example, security function 910 corresponds to the server's security function 216 while the MNC 902 corresponds to a nonce generated by the security server's security routine 214. The information 920 includes a key generated as part of a unilateral authentication procedure (UA KEY) 910 and an expected mobile node response (EMNR) 912 as a result of processing by the security function 910.

Following generation of the mutual authentication values 820, the security server generates multiple sets of security information each set including an MNC 902, UA key 910 and EMNR 912. This set of information provides the base station 110 the ability to perform unilateral authentication of the mobile node 112 without having to contact the security server 101. Timers may be associated with each of the sets of information 920 generated for mutual authentication purposes indicating the period of time for which the set of information is to remain valid. These timers, in accordance with one embodiment of the present invention are shorter that the timer associated with the MAT 828 generated as part of the mutual authentication process.

Referring once again to FIG. 5, in step 508, the base station 110 receives the security information, e.g., information 820 and 920 as well as the mobile node challenge (MNC) 802, generated by the security server 101. This information includes the encryption key 822 generated as part of the mutual authentication process, the BSR 824 to be used in replying to the received BSC, EMNR 826 to be used to determine the authenticity of the MN 112 based on its response to MNC 802. It also includes one or more sets of MNCs 902, UA keys 910 and EMNRs 912 to be used in performing unilateral authentication and subsequent data encryption.

Next in step 510, the base station 110 transmits the BSR 824 and the MNC 802 to be used as part of the mutual authentication process to the mobile node 112. Then, in step 514 the base station 110 receives the mobile node's response (MNR). In step 514 the received MNR is compared to the EMNR 826 supplied by the security server 101. In step 516 a determination is made as to whether or not the received MNR matches the EMNR 826. If they do not match interaction with the mobile node 112 stops in step 518 otherwise operation proceeds to step 520 wherein encryption of communications, e.g., data sent to the mobile node 112 and decryption of data received from the mobile node commences. For encryption/decryption purposes in step 520 the base station 110 uses the key 822 generated as part of the mutual authentication process to encrypt/decrypt communications with the mobile node.

Periodically, or in response to a signal received from the mobile node 112, the base station 110 determines in step 522 if a handoff of the mobile node 112 to another base station 110′ or 110″ is required. Such a handoff may be required, for example because the mobile node 112 is leaving the first cell 102 and entering the second cell 104. If no handoff is required, communication with the mobile node 112 continues in step 524, e.g., using the key 822 for encryption/decryption purposes.

If in step 522 it is determined that a handoff to a new base station, e.g., base station 110′ is required, operation proceeds to step 526. In step 526, the first base station 110 transmits to the new base station state information relating to mobile node 112 which is being handed off to the new base station 110′. The transmitted information includes the set 330, 332, 334 of MNCs, EMNRs and keys generated by the security server to be used in conjunction with a unilateral authentication operation. The MAT 352 is also included in the transferred information. Since the transfer occurs between base stations 110, 110′ over secure communications channel 120, the transferred state information is not likely to be intercepted or otherwise compromised.

With the transfer of state information complete, in step 528, the base station 110 terminates interaction with mobile node 112.

In the embodiment described in FIG. 5, the base station 110 is responsible for comparing a received MNR to an expected MNR generated by the security server 101. In other embodiments, this comparison is performed by the security server 101 instead of the base station 110. In such embodiments the security server conveys the results of the comparison to the base station which received the response. The base station 110 then decides, based on the information received from the security server 101 whether to terminate the interaction with the mobile node 112 or to begin data encryption/decryption. In such an embodiment, generation of the MNCs and EMNRs to be used in unilateral authentication operations is not performed in cases where the security server 101 determines that the received MNR does not match the EMNR that is being used as part of the mutual authentication process.

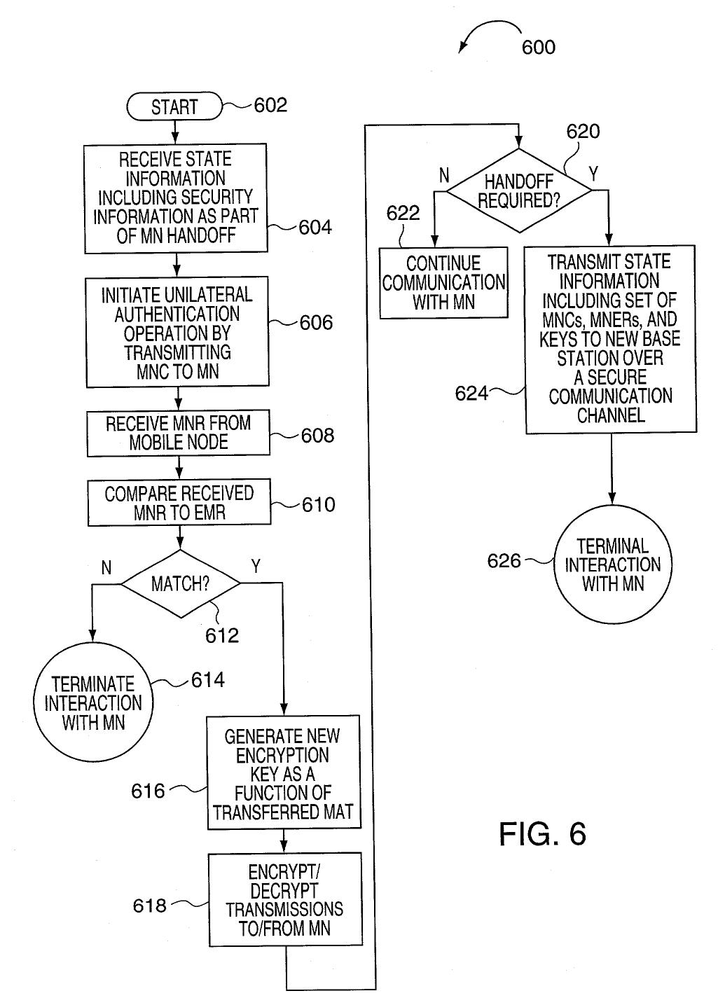

FIG. 6 illustrates the steps performed by a base station 110′ that takes over responsibility for communicating with a mobile node 112 as part of a handoff operation. In start step 602 the base station 110′ detects a transmission from another base station 110 indicating that a hand off operation is to be performed. Then, in step 604 the base station 110′ receives state information as party of the mobile node 112 handoff. The state information includes security information, e.g., MAT 352 and sets of unilateral authentication information 330, 332, 334 which includes keys 337 and timers 338 in addition to MNCs 335 and EMNRs 336.

Following receipt of the state information, in step 606 the base station 110′ initiates a unilateral authentication operation by transmitting an unused one of the mobile node challenges 335, that was received as part of the state information, to the mobile node 110.

In step 608 the base station receives the mobile node response (MNR) to the transmitted challenge. Then, in step 610 the received MNR is compared to the EMNR 336 obtained from the transferred state information. If the received MNR fails to match the EMNR operation proceeds to step 614 through decision step 612. In step 614 the interaction with the mobile node 112 is terminated due to the failure of the unilateral authentication operation.

However, if the received MNR matches the EMNR operation proceeds from step 610 to step 616 by way of decision step 612. In step 616 a new encryption key is generated as a function of the transferred MAT 352. Since the new encryption key is a function of a value, the MAT 352, which was generated from the shared secret and since the MAT was transmitted between base stations using a secure communications channel, the mobile node can trust the base station as being a legitimate entity if the mobile is able to correctly decrypt the encrypted data using a new key which it also generates from the MAT. In essence, the MAT serves as a short term shared secret common to base stations to which state information was transferred in a secure fashion directly or indirectly from a base station which performed a mutual authentication operation with the mobile node 112. The mobile node can trust the base station since it has a copy of the MAT 352 without the need for the base station to contact the security server 101 and without the base station requiring access to the long term shared secret known only to the security server 101 and mobile node 112.

In the exemplary embodiment shown in FIG. 10, the new encryption key 1008, to be used following unilateral authentication of the mobile node, is generated by logical XORing the key 337 transmitted as part of the state information corresponding to the mobile node challenge used in the authentication operation. Thus, the new key 1008 to be used for encryption/decryption purposes is a function of the MAT 352 which is hidden from the public networks and nodes and never exchanged between the mobile node 112 and any of the base stations 110, 110′, 110″.

Following generation of the new encryption key as a function of the MAT 352, the new base station 110′ encrypts/decrypts transmissions sent to/from the mobile node 112 using the new encryption key.

Periodically, in step 620, a determination is made as to whether a handoff of the mobile node 112 to another base station 110 or 110″ is required. If no handoff is required communication continues with the mobile node in step 622. However, if a handoff is required operation proceeds to step 624. In step 624 state information is transferred to a new base station as part of a handoff operation. Then in step 626 the base station 110′ terminates interaction with the mobile node in step 626.

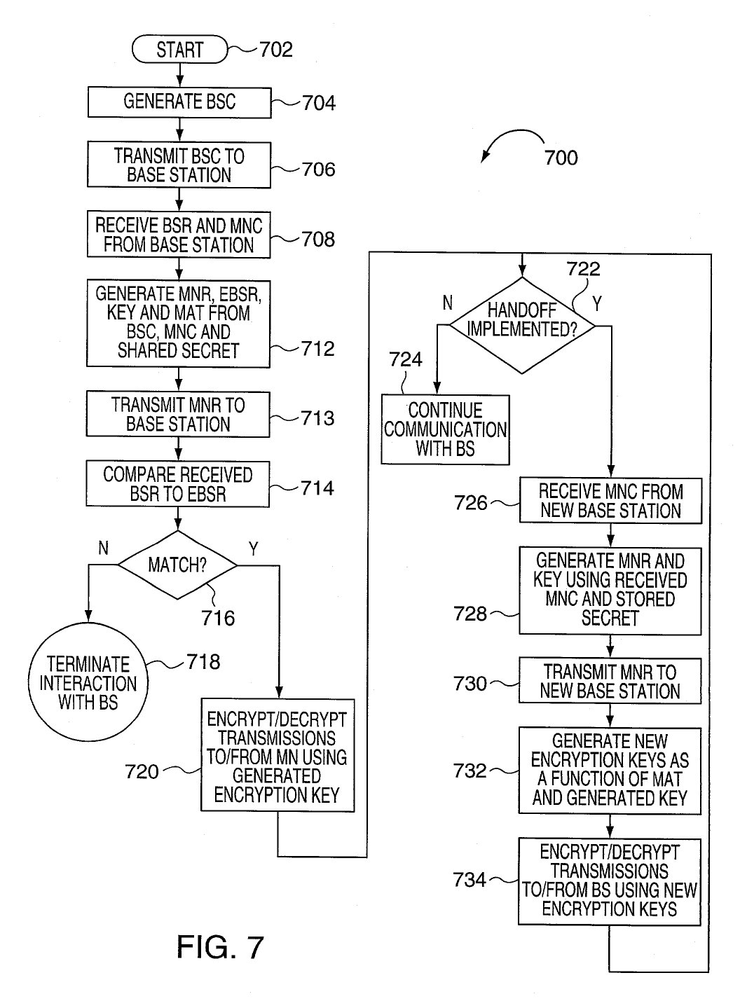

FIG. 7 illustrates the steps performed by a mobile node 112 operating in accordance with the present invention. Operation begins in start step 702, e.g., with the mobile node 112 being turned on. Then, in step 704, the mobile node generates a base station challenge (BSC) 422. The base station challenge is generated by a random number generator sub-routine included in security routine 414. Next, in step 706, the mobile node 112 transmits the BSC 422 to the base station 110. Then, in step 708, the mobile node receives a base station response (B SR) and mobile node challenge (MNC) 430 from the base station 110.

In step 712, the mobile node 112 generates, using the shared secret 417, BSC 422 and MNC 430, a mobile node response 432, an expected base station response 424, key 425 and MAT 426. Generation of these values may be performed using the shared secret and a security function as shown in FIG. 8. In step 713 the mobile node sends the MNR 432 to the base station for verification. Next, in step 714 the generated EBSR 424 is compared to the received BSR. If the BSR does not match the EBSR 424 the mutual authentication operation fails and interaction with the base station 110 is terminated in step 718. However, if the received BSR matches the EBSR 424 and the base station 110 has not terminated the interaction, mutual authentication was successful and operation proceeds to step 720 via match determination step 716. In step 720 the mobile node begins to encrypt communications to the base station 110 and to decrypt communications received from the base station 110 using the key 425 generated as part of the mutual authentication process.

Operation proceeds from step 720 to step 722 wherein the mobile node periodically determines if a handoff operation was implemented by the base station 110. If no handoff operation has occurred communication continues with the base station 110 in step 724. However, if a handoff has occurred, operation proceeds to step 726 which is the start of a unilateral authentication operation with a new base station 110′.

In step 726 the mobile node 112 receives a mobile node challenge (MNC) form the new base station, e.g., the base station 110′ corresponding to a cell the mobile node 112 is entering. Next, in step 728 the mobile node 112 generates a mobile node response (MNR) 432 and a key 425 using the received MNC and the stored secret 417. The generation of the MNR 432 and key 425 may be performed in the manner shown in FIG. 9 In step 730 the generated MNR 432 is transmitted to the base station 110′ to complete the unilateral authentication of the mobile node 112. Then, in step 732 the mobile node generates a new encryption key 425 to replace the existing key 425 that was just generated. The new encryption key 425 is generated as a function of the MAT 426 and the previous version of the key 425 that was generated in step 728. The new encryption key may be generated using the XOR method shown in FIG. 10.

The new encryption key generated as a function of the MAT 426 is used in step 734 to encrypt/decrypt transmissions, e.g., data, sent to and received from, the base station 110′. With the successful generation of the new encryption key 425 and encryption/decryption of communications with the new base station 110′ operation proceeds to step 722 wherein a check to determine if a handoff has occurred.

Assuming that the mobile node 112 can decrypt the received information using the key 425 generated using the MAT 426, the mobile node can be reasonable certain that it is dealing with a legitimate base station since a rogue base station is unlikely to have access to the MAT 426 which is not transmitted between the base station 110 and mobile node 112 at any time.

In the above described embodiment, a mutual authentication operation occurs when a mobile node 112 attempts to contact a base station 110 in the system 100 for the first time. The timer 428 associated with the MAT can be used to determine when a new mutual authentication operation is to be performed and a new MAT generated. Alternatively, running out of CRK sets may be used to signal that a new mutual authentication is to be performed. In addition to or alternatively to generating a new encryption key 425 each time the mobile node is handed off to a new base station 110, the timer 338 associated with each set 330, 332, 334 of unilateral authentication information can also be used to determine when a new unilateral authentication operation should be performed and a new encryption key generated as a function of the MAT 426. In one embodiment, the timers 338 corresponding to each set of unilateral authentication information 330, 332, 334 is a fraction of the duration of the timer 354 associated with the MAT 352. As a result several keys may be generated based on unilateral authentication of the mobile node and the MAT 352 before the security sever 101 needs to be contacted to perform another mutual authentication operation using the shared secret.

While various exemplary embodiments have been described above for purposes of explaining the present invention, numerous variations are possible while remaining within the scope of the present invention.

For example, in other embodiments of the invention security information 320 does not contain the CRK sets; instead, it can include other information that can be used to establish a new encryption key with the mobile node. For example, a temporary key that the security server 101 gives to the base station 110 to use as a basis for authenticating the mobile, or prescribed parameters that the base station 110 and mobile 112, 114 can use to perform unauthenticated key establishment such as what is known in the art as the Diffie-Hellman key exchange. Thus, the establishment of a new encryption key need not be linked to unilateral authentication.

Mutual authentication may be achieved by other techniques, for example two unilateral authentications: first base authenticates mobile (such as challenge/response handshake), a “MAT1” is generated; then, the mobile node authenticates the base station, and a “MAT2” is generated. Then, the MAT can be formed from MAT1 and MAT2, e.g. by concatenation or similar operation.

In other embodiments of the mutual authentication task, the order of the transmission of the challenges may be switched, i.e. the mobile node receives the challenge MNC, then sends its response MNR and its challenge BSC, then receives the base station response BSR.

An encryption key need not be derived upon mutual authentication. The encryption key can be derived later through unilateral authentication. In such an embodiment the MAT is still used in generating the encryption key.

In the mutual authentication process, the base station may act as a passive device, e.g., it need not know the details of the authentication protocol that the server and the mobile are engaging in. That is, mutual authentication is performed between the mobile node and the security server. Thus, for example, the server generates the base station challenge BSC. In this scenario, the base station receives an acceptance message from the server indicating the mobile node is authenticated, along with the MAT and other information such as the CRK sets to use for this mobile node. The base station can now use the MAT as described above. Thus the mobile node authenticates the security server and then trusts the base station because the mobile node receives the right response through it, and because the base station has the MAT, i.e. encryption is working. If mutual authentication is unsuccessful, then the server sends a message to the base station indicating so, and a prescribed course of action is taken, e.g. connection with the mobile node is terminated.

A new encryption key need not be established upon handoff. Instead, in some embodiments, new encryption key is established upon expiration of the time associated with a key that is being used. In such an embodiment, generation and/or use of new encryption keys is timer controlled as opposed to depending on the occurrence of a handoff. In such an embodiment several handoffs (0, 1, 2, or more) may have happened since the last key was established. Similarly, there may be no unilateral authentication performed upon mobile handoff. Unilateral authentication may be performed with a new base station based on a timer associated with the encryption key that was passed on from the previous base station upon mobile node handoff. In some embodiments, a combination of timer and handoff control is used to determine when new encryption keys are generated, e.g., using the MAT of the present invention. For example, a new encryption key may be generated whenever there is a handoff and also in the event of expiration of timer associated with a key that is being used.

What is claimed is:

1. A security method for use in a communication system including at least one mobile node that includes a secret value and a plurality of nodes that are coupled to a security server that also stores said secret value, the method comprising:
operating the security server to generate a token from said stored secret and to communicate said token to a first one of said plurality of nodes;
operating the first one of said plurality of nodes to communicate with said mobile node;
transferring the generated token from said first one of said plurality of nodes to a second one of said plurality of nodes;
operating the second one of said plurality of nodes to generate a new encryption key from said token; and
operating the second one of said plurality of nodes to communicate with said mobile node using said new encryption key to encrypt at least some data transmitted to said mobile node.

2. The method of claim 1, wherein said new encryption key is generated as a function of both said token and a key generated from at least some information transmitted to the mobile node.

3. The method of claim 2, further comprising:
operating the mobile node to generate said token from said shared secret value.

4. The method of claim 3, wherein the step of operating the mobile node to generate said token further includes:
operating the mobile node to use information, received from at least one of the first one of said plurality of nodes and said security server, in addition to said shared secret to generate said token.

5. The method of claim 4, wherein the first one of the plurality of nodes is a base station.

6. The method of claim 5, further comprising:
operating a subsequent one of said plurality of nodes to perform unilateral authentication of said mobile node prior to operating the second one of said plurality of nodes to communicate with said mobile node using said new encryption key.

7. The method of claim 6, wherein said at least some information from which said key is generated is a mobile node challenge transmitted as part of said unilateral authentication of said mobile node.

8. The method of claim 1, wherein the step of operating the security server to generate a token from said stored secret includes:
using said stored secret and at least some information communicated between the first one of said plurality of nodes and said mobile node as input to a security function which generates said token.

9. The method of claim 8, wherein said security function is one of a Message Authentication Code, a hash function and a HMAC.

10. The method of claim 8, wherein said input to the security function includes a challenge transmitted to said mobile node.

11. The method of claim 10, wherein said challenge is generated by the security server.

12. The method of claim 10, wherein said challenge is generated by the first of said plurality of nodes.

13. The method of claim 10, wherein said input to the security function includes a challenge received by said first of said plurality of nodes from said mobile node.

14. The method of claim 1, further comprising:
operating said security server to generate, using said shared secret, a set of security information including a plurality of mobile node challenges and expected mobile node responses, each expected mobile node response corresponding one of said mobile node challenges and being a function of said shared secret; and
supplying said generated set of security information to said first one of plurality of nodes.

15. The method of claim 8, wherein said step transferring the generated token from said first one of said plurality of nodes to a second one of said plurality of nodes is performed as part of a mobile node handoff operation, said mobile node handoff operation further comprising:
transferring at least a portion of said set of security information generated by said security server from said first one of the plurality of nodes to the second one of said plurality of nodes.

16. The method of claim 15, further comprising:
operating the subsequent one of said plurality of nodes to perform unilateral authentication of said mobile node prior to operating the subsequent one of said plurality of nodes to communicate with said mobile node using said new encryption key.

17. The method of claim 16, wherein the step of operating the second one of said plurality of nodes to perform unilateral authentication of said mobile node includes:
transmitting a mobile node challenge included in the transferred portion of said set of security information to said mobile node; and
comparing a mobile node response received from the mobile node to an expected mobile node response included in the transferred portion of said set of security information.

18. The method of claim 17, further comprising:
operating the security server to generate a new token from said shared secret after a preselected period of time; and
operating one of said plurality of base stations to:
i) use said new token to generate another new encryption key; and
ii) use said generated another new encryption key to encrypt data transmitted to the mobile node.

19. The method of claim 15, further comprising:
operating the security server to perform a mutual authentication operation and to generate a new token from said shared secret using information received by said security server from one of said plurality of nodes.

20. The method of claim 19, wherein said information received by said security server is information transmitted from said mobile node to said one of said plurality of nodes.

21. The method of claim 15, wherein the transferred portion of said set of security information includes the encryption key used by said first one of said plurality of nodes to encrypts information transmitted to said mobile node, the method further comprising:
operating the second one of said plurality of nodes to use the transferred encryption key previously used by said first one of said plurality of nodes to encrypt information sent by said second one of said plurality of nodes to said mobile node.

22. The method of claim 21, further comprising the step of:
determining when a timer associated with the encryption key used by said first one of said plurality of nodes expires; and
wherein said step of operating the second one of said plurality of nodes to generate a new encryption key occurs in response to determining that said timer has expired.

23. The method of claim 1, further comprising:
operating the first one of said plurality of nodes to transfer an encryption key and an associated timer to said second one of said plurality of nodes; and
wherein said new encryption key generated by said second one of the plurality of nodes is used to encrypt said at least some data after said associated timer expires.

24. The method of claim 23, further comprising the step of:
determining when a timer associated with the encryption key used by said first one of said plurality of nodes expires; and
wherein said step of operating the second one of said plurality of nodes to generate a new encryption key occurs in response to determining that said timer has expired.

25. A communication system including:
a security server including:
a secret value corresponding to a mobile node;
means for generating a token from said secret value; and
means for communicating said token to a base station;
a first base station coupled to said security server, the first base station including:
means for communicating with a mobile node;
a memory for storing said token generated by said security server and a first encryption key used to encrypt information transmitted to said mobile node; and
means for transmitting said token to another base station as part of a mobile node handoff operation; and
a second base station coupled to said first base station, the second base station including:
means for generating as second encryption key as a function of said token following a handoff operation involving the transfer of said token from said first base station to said second base station.

26. The communication system of claim 25, wherein said token and said first encryption key are stored in said memory of said second base station, the base station further including:
means for detecting when a timer associated with said first encryption key expires.

27. A method of operating a mobile node in a communication system including a plurality of nodes that are coupled by a communications channel to a security server that stores a secret value corresponding to said mobile node, the method comprising:
storing said secret value in said mobile node;
performing a mutual authentication operation with a first one of said base stations using said shared secret to generate at least one value transmitted to said first one of said base stations as part of the mutual authentication operation;
generating a token as a function of said stored secret value;
generating an encryption key as a function of said generated token; and
encrypting information sent to a second one of said plurality of nodes using said generated encryption key.

28. The method of claim 27, further comprising:
providing unilateral authentication information to said second one of said plurality of nodes prior to performing said step of encrypting information.

29. The method of claim 28, wherein said step of generating an encryption key includes:
performing an operation using said token and a value obtained from information passed between said second node and said mobile node to generate said encryption key.

30. The method of claim 28, further comprising:
storing a first timer associated with said token.

31. The method of claim 30, further comprising:
performing a mutual authentication operation with one of said plurality of nodes in response to expiration of said timer.

32. The method of claim 31, further comprising:
storing a second timer associated with said generated encryption key, said second timer having a shorter length than said first timer.

33. The method of claim 32, further comprising the step of:
using a new encryption key to encrypt information transmitted by said mobile node in response to expiration of said second timer.

34. The method of claim 33, further comprising the step of:
generating a new token as a function of said shared secret in response to expiration of said first timer.

35. A mobile node for use in a communication system including a plurality of nodes that are coupled by a communications channel to a security server, the security server storing a secret value corresponding to said mobile node, the mobile mode comprising:
a memory including said secret value;
means for performing a mutual authentication operation with a first one of said base stations;
means for performing a mutual authentication operation with a first one of said base stations using said shared secret to generate at least one value transmitted to said first one of said base stations as part of the mutual authentication operation;
means for generating a token as a function of said stored secret value;
means for generating an encryption key as a function of said generated token; and
means for encrypting information sent to a second one of said plurality of nodes using said generated encryption key.

36. The mobile node of claim 35, further comprising:
means for providing unilateral authentication information to said second one of said plurality of nodes.

37. The mobile node of claim 36, wherein said means for generating an encryption key includes an encryption module for performing an operation using said token and a value obtained from information passed between said second node and said mobile node to generate said encryption key.

38. The mobile node of claim 37, further comprising:
a first timer associated with said token; and
a second timer associated with said encryption key, said second timer being a shorter timer than said first timer.
